(19) United States
(12) Patent Application Publication
(10) Pub. No.: US 2014/0331025 A1
(43) Pub. Date: Nov. 6, 2014

(54) RECONFIGURABLE PROCESSOR AND OPERATION METHOD THEREOF

(71) Applicant: SAMSUNG ELECTRONICS CO., LTD., Suwon-si (KR)

(72) Inventors: Ki-Seok KWON, Seoul (KR); Suk-Jin KIM, Seoul (KR)

(73) Assignee: SAMSUNG ELECTRONICS CO., LTD., Suwon-si (KR)

(21) Appl. No.: 14/269,560

(22) Filed: May 5, 2014

(30) Foreign Application Priority Data
May 3, 2013 (KR) 10-2013-0050249

(51) Int. Cl. G06F 9/38

(52) U.S. Cl. CPC G06F 9/3889
USPC 712/20

(57) ABSTRACT

A reconfigurable processor and an operation method thereof are provided. The reconfigurable processor may include: a controller configured to control operations of a first mode, in which a first portion of a program that does not utilize loop acceleration is processed, and a second mode, in which a second portion for the program that utilizes the loop acceleration is processed, based on whether an instruction to control parallel operations of the first mode and the second mode is executed; and a shared register file configured to transfer data between the first mode and the second mode.

### CROSS-REFERENCE TO RELATED APPLICATION

This application claims priority from Korean Patent Application No. 10-2013-0050249, filed on May 3, 2013 in the Korean Intellectual Property Office, the entire disclosure of which is incorporated herein by reference for all purposes.

### BACKGROUND

1. Field

Apparatuses and methods consistent with exemplary embodiments relate to a reconfigurable processor and an operation method thereof.

2. Description of the Related Art

A related art Coarse Grained Array (CGA) processor has two operation modes. One operation mode is a Very Long Instruction Word (VLIW) mode, which operates as a related art VLIW processor. In this mode, the related art CGA processor receives instructions from an instruction memory, operates, and is in charge of a portion that is not subject to loop acceleration, such as a program flow control, etc. The other one is a CGA mode (also called Coarse Grained Reconfigurable Array (CGRA) mode), which is in charge of acceleration of a loop portion within a program.

Here, the CGA processor operates in one mode at a time, and does not operate a processor control function, such as an interrupt process, while operating in the CGA mode. In addition, while operating in the CGA mode, the CGA processor does not use the instruction memory, and while operating in the VLIW mode, the CGA processor does not use a configuration memory, and (in some cases) some parts of a processing device, so a hardware usage rate is decreased.

Recently, in many cases for a digital signal processing system, a plurality of processors (a multi-processor system) are used to improve processing performance. However, as the number of processors increases, a hardware area is enlarged, and an area of a system bus connecting the processors exponentially grows. As a result, the process performance may not be improved since overhead increases in direct proportion to the number of processors.

Thus, there are difficulties in equally dividing a program capable of operating in a single processor so as to operate in multiple processors. Also, additional time for sending, receiving, or synchronizing data between processors is needed.

### SUMMARY

According to an aspect of an exemplary embodiment, there is provided a reconfigurable processor including: a controller configured to control operations of a first mode, in which a first portion of a program that does not utilize loop acceleration is processed, and a second mode, in which a second portion of the program that utilizes the loop acceleration is processed, based on whether an instruction to control parallel operations of the first mode and the second mode is executed; and a shared register file configured to transfer data between the first mode and the second mode.

The first mode may operate based on a VLIW architecture.

The second mode may operate based on a CGA architecture.

In response to a second mode operation instruction being executed in the first mode, the controller may operate the second mode to execute an instruction and may operate the first mode to execute an instruction processible in parallel with the instruction being executed in the second mode.

In response to a second mode end waiting instruction being executed in the first mode, the controller may determine whether the second mode is operating, and in response to determining that the second mode is operating, stop an operating of the first mode until the operating of the second mode ends.

In response to a second mode ending instruction being executed in the first mode, the controller may end an operating of the second mode.

The reconfigurable processor may further include data memory configured to transfer data between the first mode and the second mode.

According to an aspect of another exemplary embodiment, there is provided a reconfigurable processor including: a VLIW core including one or more functional units; a CGA core including a plurality of functional units; a shared register file configured to transfer data between the VLIW core and the CGA core; and a controller configured to control operations of the VLIW core and the CGA core based on whether an instruction to control parallel operations of the VLIW core and the CGA core is executed.

In response to a CGA core operation instruction being executed in the VLIW core, the controller may operate the CGA core to execute an instruction and may operate the VLIW core to execute an instruction processible in parallel with the instruction being executed in the CGA.

In response to a CGA core end waiting instruction operating in the VLIW core, the controller may determine whether the CGA core is operating, and in response to determining that the CGA core is operating, may stop an operating of the VLIW core until the operating of the CGA core ends.

In response to a CGA core ending instruction being executed, the controller may end an operating of the CGA core.

In response to the CGA core not operating, the VLIW core may use at least one of the plurality of functional units of the CGA core.

According to an aspect of another exemplary embodiment, there is provided an operation method of a reconfigurable processor, the method including: executing an instruction in a first mode; determining whether an instruction to control parallel operations of the first mode and a second mode is executed in the first mode; and in response to determining that the instruction to control parallel operations of the first mode and the second mode is executed, controlling operations of the first mode and the second mode based on the executed instruction.

The first mode may operate based on a VLIW architecture.

The second mode may operate based on a CGA architecture.

In response to a second mode operation instruction being executed in the first mode, the controlling the operations of the first mode and the second mode may include operating the second mode.

In response to the first mode processing an instruction executable in parallel with an instruction being executed in the second mode, the first mode and the second mode may simultaneously operate.

The controlling the operations of the first mode and the second mode may further include: determining whether an operating of the second mode is ended in response to a second mode end waiting instruction being executed in the first mode; stopping an operating of the first mode in a case in which the operating of the second mode is not ended; and restarting the operating of the first mode in a case in which the operating of the second mode operation ends after the stopping of the operating of the first mode.

In response to a second mode operation ending instruction being executed in the first mode, the controlling the operations of the first mode and the second mode may include ending an operating of the second mode.

The controlling the operations of the first mode and the second mode may further include: determining whether the second mode is being operated in response to the second mode operation ending instruction being executed in the first mode; stopping an operating of the first mode in a case in which the second mode is operating; ending the operating of the second mode; and restarting the operating of the first mode after the ending the operating of the second mode.

According to an aspect of another exemplary embodiment, there is provided a reconfigurable processor, including: a first core in which a first portion of a program that does not utilize loop acceleration is processed; a second core in which a second portion of the program that utilizes the loop acceleration is processed; and a controller configured to control operations of the first core and the second core based on whether an instruction to control parallel operations of the first core and the second core is executed.

The reconfigurable processor may further include a storage configured to transfer data between the first mode and the second mode.

### BRIEF DESCRIPTION OF THE DRAWINGS

The above and/or other aspects will be more apparent by describing exemplary embodiments with reference to the accompanying drawings, in which:

FIG. 1 is a block diagram illustrating an example of a reconfigurable processor, according to an exemplary embodiment;

FIG. 2 is a detailed diagram illustrating an example of a reconfigurable processor, according to an exemplary embodiment;

FIG. 3 is a diagram illustrating examples of a CGA core operation instruction, according to one or more exemplary embodiments;

FIGS. 4A and 4B are diagrams illustrating examples of a code used for a VLIW core, and a code used for a CGA core, according to an exemplary embodiment;

FIG. 5 is a flowchart illustrating an example of a process of a reconfigurable processor operation, according to an exemplary embodiment;

FIG. 6 is a flowchart illustrating an example of a process of controlling operations of a VLIW core and a CGA core if a CGA core operation instruction is executed, according to an exemplary embodiment;

FIG. 7 is a flowchart illustrating an example of a process of controlling operations of a VLIW core and a CGA core if a CGA core end waiting instruction is executed, according to an exemplary embodiment; and

FIG. 8 is a flowchart illustrating an example of a process of controlling operations of a VLIW core and a CGA core if a CGA core ending instruction is executed, according to an exemplary embodiment.

### DETAILED DESCRIPTION OF EXEMPLARY EMBODIMENTS

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Throughout the drawings and the detailed description, unless otherwise described, the same drawing reference numerals will be understood to refer to the same elements, features, and structures. The relative size and depiction of these elements may be exaggerated for clarity, illustration, and convenience. Furthermore, it is understood that, hereinafter, expressions such as “at least one of,” when preceding a list of elements, modify the entire list of elements and do not modify the individual elements of the list.

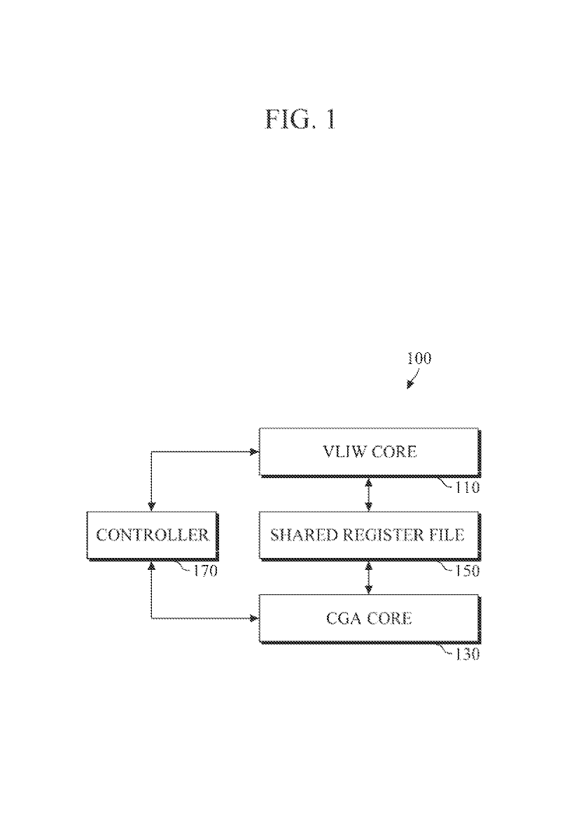

FIG. 1 is a rough diagram illustrating an example of a reconfigurable processor 100, according to an exemplary embodiment.

Referring to FIG. 1, a reconfigurable processor 100 may include a plurality of modes (e.g., a Very Long Instruction Word (VLIW) core 110 and a Coarse Grained Array (CGA) core 130), a shared register file 150, and a controller 170.

The VLIW core 110 is capable of, in a program, processing portions that do not utilize or require loop acceleration, and the CGA core 130 is capable of, in a program, processing portions that utilize or require loop acceleration.

Here, whether a predetermined portion in a program utilizes the loop acceleration may be determined either by a programmer who directly marks a portion that utilizes the loop acceleration in a source code, etc., and provides information about the portion to a compiler, or by the compiler itself.

Specifically, the compiler may determine which portion utilizes the loop acceleration based on the information that the programmer provides, or according to a determination of the compiler itself, may generate a code used for the CGA core for the portion that utilizes the loop acceleration within the program, and generate a code used for the VLIW core for the other portion.

A shared register file 150 may execute an operation of transferring data between the VLIW core 110 and CGA core 130.

A controller 170 may control parallel operations of the VLIW core 110 and the CGA core 130.

Specifically, according to whether the VLIW core 110 executes an instruction that controls the parallel operations of the VLIW core 110 and the CGA core 130, the controller 170 may control the operations of the VLIW core 110 and the CGA core 130.

Here, the instruction to control the parallel operations between the VLIW core 110 and the CGA core 130 may be inserted into the code used for the VLIW core by the programmer or the compiler.

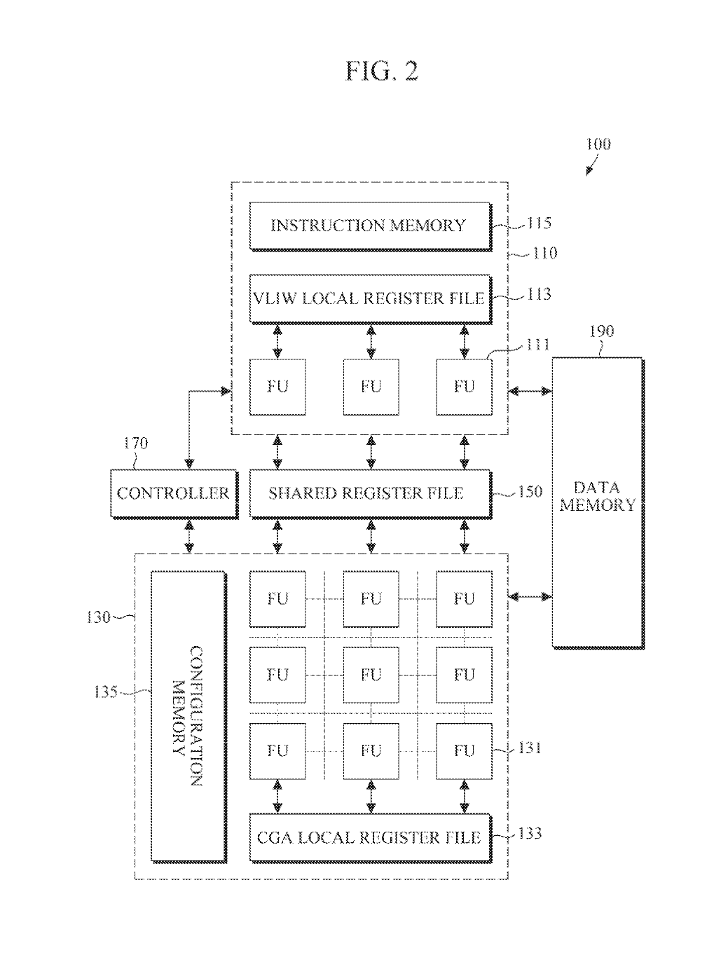

FIG. 2 is a detailed diagram illustrating an example of a reconfigurable processor 100, according to an exemplary embodiment.

Referring to FIG. 2, a VLIW core 110 may include one or more functional units 111, a VLIW local register file 113, and an instruction memory 115.

Each functional unit 111 may execute an instruction, and be capable of independently processing a portion that is not dependent on another.

A VLIW local register file 113 is a set of one or more registers, and may temporarily store data used by, or results calculated by, the functional units 111.

The instruction memory 115 provides the instruction to be executed by the VLIW core 110, and may include at least one of an instruction cache, an instruction fetcher, and an instruction decoder.

An instruction cache may include memory that stores instructions. In a case where the instruction that an instruction fetcher requests is stored in the instruction cache, the instruction cache may directly transfer the stored instruction to the instruction fetcher. Conversely, in a case where the instruction is not stored in the instruction cache, the instruction cache fetches the instruction from an external memory, and transfers the instruction to the instruction fetcher.

An instruction fetcher may request the instruction cache to provide either an instruction to be executed, or an instruction expected to be executed, by the VLIW core 110, and may transfer the instruction received from the instruction cache to an instruction decoder.

An instruction decoder may interpret the instruction that the instruction fetcher transfers, and generate a control signal.

In an exemplary embodiment, because a plurality of instructions processible in parallel in one instruction word of the VLIW core are included, each of the functional units 111 may process in parallel the plurality of the instructions included in the instruction word.

A CGA core 130 may include a plurality of functional units 131, a CGA local register file 133, and configuration memory 135.

The plurality of the functional units 131 of the CGA core 130 may be connected to each other, and each connection state between each of the functional units 131 may be changed.

Information about the connection states between the plurality of the functional units 131 may be referred to as configuration information, and may be stored in the configuration memory 135.

Specifically, the CGA core 130 may change the connection states between the functional units 131, using the configuration information stored in the configuration memory 135, so the CGA core 130 may be optimized or configured for a specific loop arithmetic operation.

A CGA local register file 133 includes one or more registers, and may temporarily store data used by, or results calculated by, the functional units 131.

A shared register file 150 may include one or more registers. Also, the VLIW core 110 and the CGA core 130 may access the shared register file 150.

A plurality of data memory 190 may exist physically or logically, and at least one of the plurality of data memory 190 may be accessible from the VLIW core 110 and the CGA core 130. In this case, the data memory 190 may be connected to the two VLIW core 110 and the CGA core 130 directly or indirectly (e.g., through a bus or the like).

Since the VLIW core 110 and the CGA core 130 may access the shared register file 150 and the data memory 190, input data of the CGA core 130 may be transferred to the VLIW core 110 through the shared register file 150 or the data memory 190. Also, the CGA core 130 may receive the input data from the VLIW core 110 through the shared register file 150 or the data memory 190.

Specifically, the VLIW core 110 may store input data, and the like, to operate the CGA core 130 in the shared register file 150 or the data memory 190, and the CGA core 130 may store intermediate data and results of a loop arithmetic operation.

In other words, before the CGA core 130 operates, the VLIW core 110 may store the input data or live-in data to operate a code used for the CGA core in the shared register file 150 or the data memory 190.

Also, results or live-out data, which is calculated while the CGA core 130 operates, may be stored in the shared register file 150 or the data memory 190.

For example, after the CGA core 130 executes the loop arithmetic operation and stores results in at least one of the shared register file 150 and the data memory 190, the VLIW core 110 may execute another arithmetic operation, using the results.

A controller 170 may control the operations of the VLIW core 110 and the CGA core 130 according to whether the VLIW core 110 executes an instruction to control parallel operations between the VLIW core 110 and the CGA core 130.

Specifically, the instruction to control the parallel operations between the VLIW core 110 and the CGA core 130 may be inserted into a code used for the VLIW core by a programmer or a compiler, and be executed by the VLIW core 110.

In an exemplary embodiment, the controller 170 may operate the CGA core 130 in a case where a CGA core operation instruction is executed in the VLIW core 110.

Here, the VLIW core 110 processes the instruction processible in parallel together with the loop arithmetic operation processed in the CGA core 130, so the VLIW core 110 may operate at the same time with the CGA core 130.

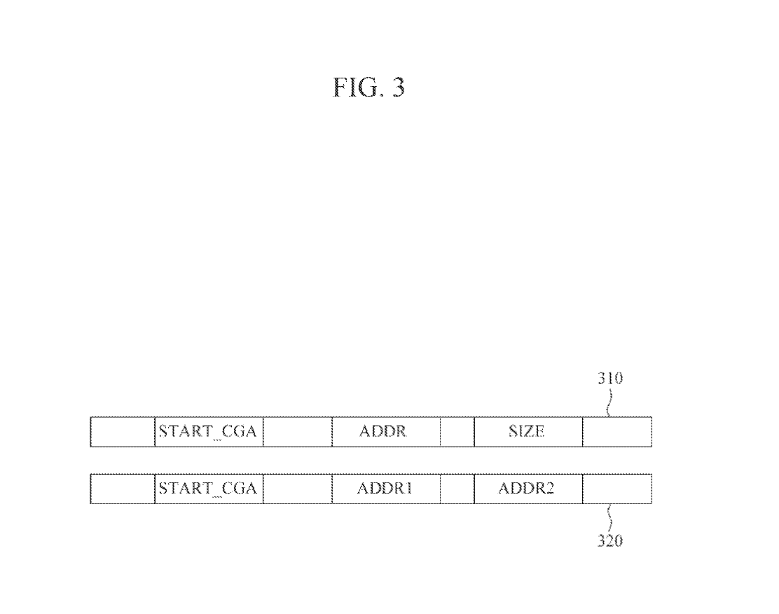

Specifically, referring to FIG. 3, a CGA core operation instruction may have at least two fields. A CGA core operation instruction 310 according to an exemplary embodiment, may include a field indicating a configuration memory address ADDR in a starting part of the CGA code 310, and another field indicating a size of the CGA code 310.

A CGA core operation 320 instruction according to another exemplary embodiment may include a field indicating a configuration memory address ADDR2 in a last part of a CGA code 320, instead of the size of the CGA code 320.

According to an exemplary embodiment, if encountering a loop end condition during the operation, the CGA core 130 of FIGS. 1 and 2 may communicate the termination of a loop arithmetic operation to the controller 170. Here, the controller 170 may control to enable the operation of the CGA core 130 to normally end, and if the operation of the CGA core 130 ends, the VLIW core 110 operates while the CGA core 130 does not operate.

Furthermore, according to an exemplary embodiment, in a case where a CGA core end waiting instruction is executed in the VLIW core 110, the controller 170 may temporarily stop the operation of the VLIW core 110 until the operation of the CGA core 130 ends.

Specifically, the VLIW core 110 may process an instruction processible in parallel with a loop arithmetic operation processed in the CGA core 130, so as to operate without stopping, even while the CGA core 130 operates.

However, in a case where there is no instruction processible in parallel with the loop arithmetic operation being processed in the CGA core 130, or where the VLIW core 110 is to use an execution result of the loop arithmetic operation of the CGA core 130, the VLIW core 110 waits until the loop arithmetic operation being processed in the CGA core 130 ends.

Thus, in a case where the CGA core end waiting instruction is executed in the VLIW core 110, the controller 170 determines whether the CGA core 130 is operating, and may temporarily stop the VLIW core 110 operation until the CGA core 130 operation ends if the CGA core 130 is determined to be operating. According to an exemplary embodiment, the controller 170 may determines whether the CGA core 130 is operating by using a CGA core end checking instruction. For example, when the CGA core end checking instruction is executed in the VLIW core 110, the controller 170 may check whether CGA core 130 is operating, and store the result of the checking in the VLIW local register file 113.

In another exemplary embodiment, in a case where a CGA core ending instruction is executed in the VLIW core 110, the controller 170 may forcibly terminate the operation of the CGA core 130.

In other words, in a case an interrupt request or an exception is processed, the controller 170 may forcibly terminate the CGA core 130 that is operating, and in a case of a system software, as well.

Therefore, in a case where an instruction to forcibly terminate the CGA core 130 is executed, the controller 170 may determine whether the CGA core 130 is operating, and end the operation of the CGA core 130 if determined to be operating. According to an exemplary embodiment, the controller 170 may determines whether the CGA core 130 is operating by using a CGA core end checking instruction. For example, when the CGA core end checking instruction is executed in the VLIW core 110, the controller 170 may check whether CGA core 130 is operating, and store the result of the checking in the VLIW local register file 113.

Here, in an exemplary embodiment, where the instruction to forcibly terminate the CGA core is executed in the VLIW core 110, the controller 170 may temporarily stop the operation of the VLIW core 110 until the CGA core 130 operation ends. In another exemplary embodiment, the controller 170 may execute the CGA core end waiting instruction after executing the instruction to forcibly terminate the CGA core in the VLIW core 130, and then temporarily stop the operation of the VLIW core 110.

In an exemplary embodiment, the controller 170 may be configured independently of the VLIW core 110 and the CGA core 130, to which the controller is not limited. According to another exemplary embodiment, the controller 170 may be included in the VLIW core 110 or the CGA core 130.

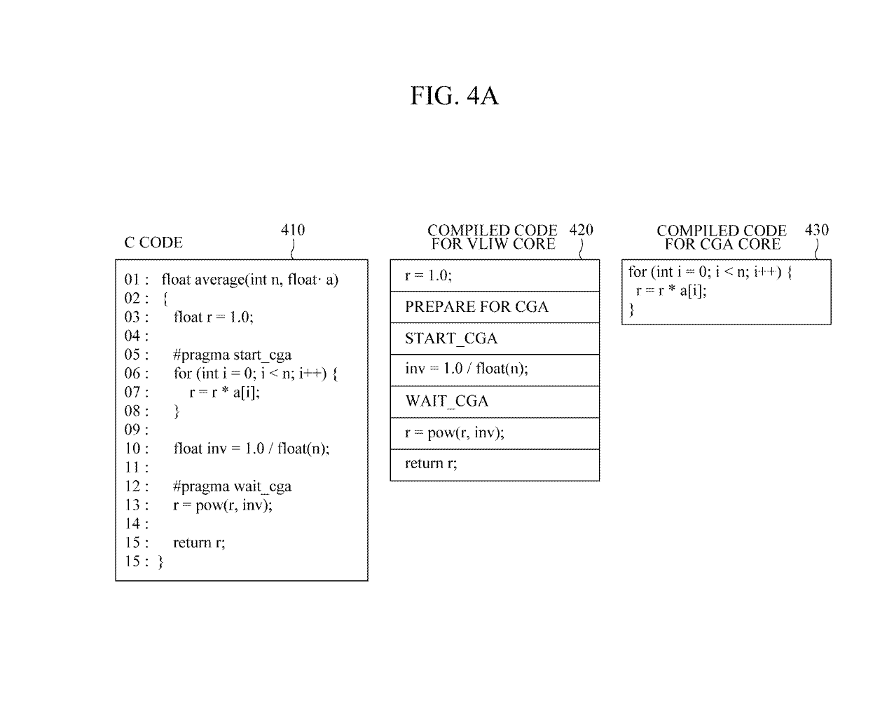

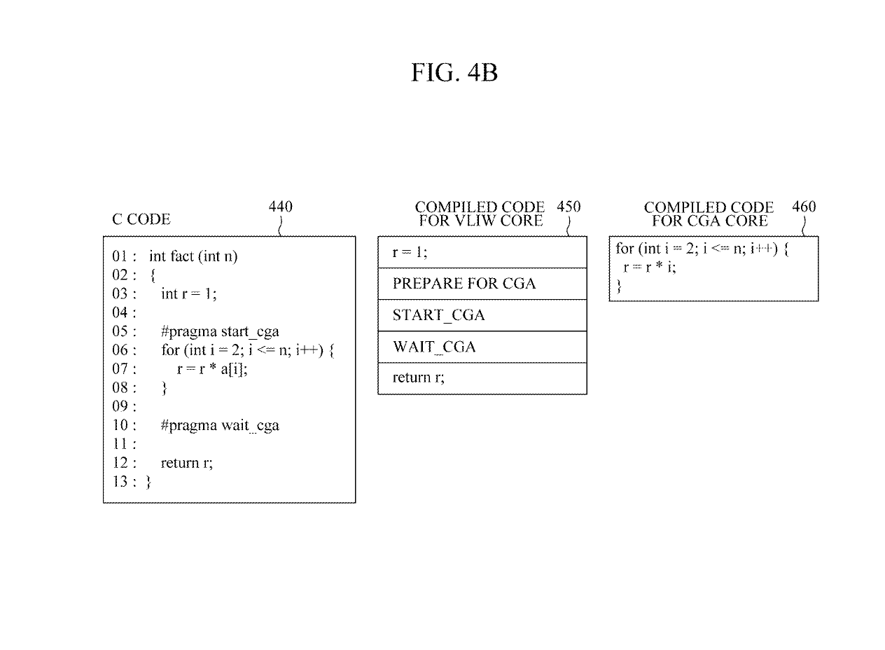

FIGS. 4A and 4B are diagrams illustrating examples of a code 420 and 450 used for a VLIW core and a code 430 and 460 used for a CGA core, according to one or more exemplary embodiments.

According to an exemplary embodiment, a compiler may generate codes 420 and 450 used for a VLIW core based on portions of a program code or flow that do not utilize loop acceleration, and codes 430 and 460 used for a CGA core based on portions of the program code or flow that utilize the loop acceleration.

Here, a programmer may determine whether the loop acceleration is utilized, and directly insert information or code into source code, and the like, accordingly. However, it is understood that one or more exemplary embodiments are not limited thereto. For example, the compiler may also make the determination of whether the loop acceleration is utilized itself.

In an illustrative example of FIGS. 4A and 4B, C codes 410 and 440 use a C language directive “#pragma” to transfer, to the compiler, information (‘start_cga’) of a portion that utilizes loop acceleration and information (‘wait_cga’) of a portion that is to be processed after a CGA core operation ends.

Referring to FIG. 4A, lines from 06 to 08 in the C code 410 are a portion that utilizes loop acceleration, and information about the portion that utilizes loop acceleration using “#pragma start_cga” is inserted to a line right ahead of line 06, i.e., line 05.

Line 10 of C code 410 is a portion that is processible in parallel with the loop arithmetic operation. However, a value calculated from the CGA core is utilized in line 13. Thus, information that the VLIW core is to wait until the CGA core operation ends using “#pragma wait_cga” is inserted to line 12.

The compiler may compile the C code 410 illustrated in FIG. 4A, and generate the code 420 used for the VLIW core, and the code 430 used for the CGA core.

Referring to the code 420 used for the VLIW core, “PREPARE FOR CGA” indicates an instruction to transfer initial data to be used by the CGA core, or to prepare for the loop arithmetic operation, by copying a local register value of the VLIW core into the shared register.

“START_CGA” indicates a CGA core operation instruction, and “WAIT_CGA” indicates a CGA core end waiting instruction.

Referring to FIG. 4B, the lines from 06 to 08 in the C code 440 are a portion that utilizes the loop acceleration, and information about the portion that utilizes loop acceleration using “#pragma start_cga” is inserted to a line right ahead of the line 06, i.e., line 05.

However, because there is not a code processible in parallel after the loop arithmetic operation in the C code 440 of FIG. 4B, “#pragma wait_cga” is inserted to line 10.

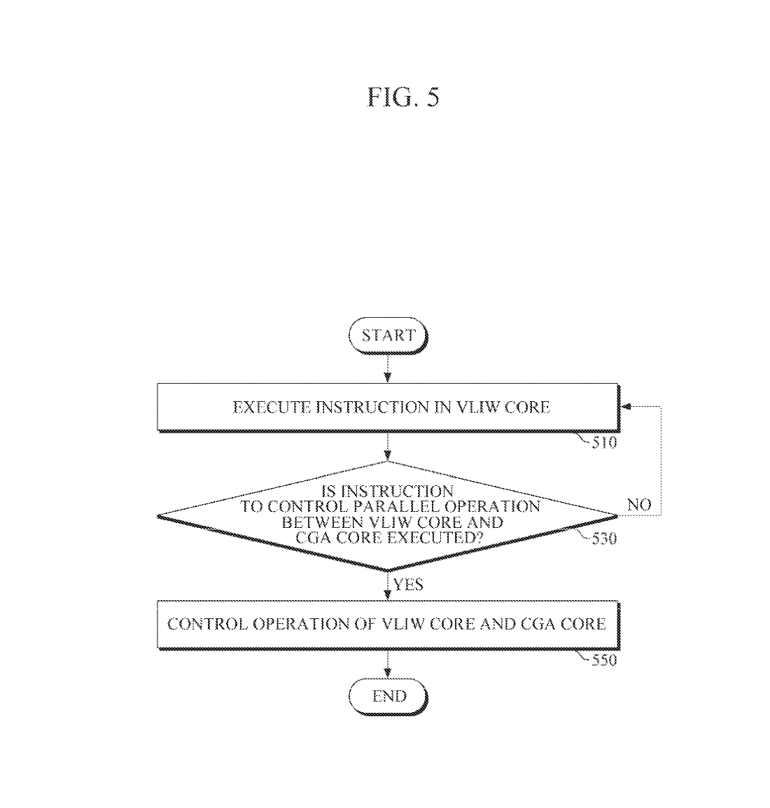

FIG. 5 is a flowchart illustrating an example of a process of a reconfigurable processor operation, according to an exemplary embodiment.

Referring to FIG. 5, a VLIW core 110 may execute an instruction of a portion of a code that does not utilize loop acceleration in a program in operation 510.

Then, depending on whether an instruction to control parallel operations of the VLIW core 110 and a CGA core 130 is executed in the VLIW core 110 in operation 530, a controller 150 may control the operations of the VLIW core 110 and the CGA core 130 in operation 550.

Here, in an exemplary embodiment, one or more instructions to control the parallel operations between the VLIW core 110 and the CGA core 130 may include an instruction to operate or end the CGA core 130, or to stop the operation of the VLIW core 110 until the CGA core 130 operation ends.

The one or more instructions to control the parallel operations of the VLIW core 110 and the CGA core 130 may be generated based on information provided by the programmer to the compiler using the source code, although it is understood that one or more exemplary embodiments are not limited thereto. For example, according to another exemplary embodiment, the one or more instructions to control the parallel operations of the VLIW core 110 and the CGA core 130 may be generated after the compiler determines the portion itself.

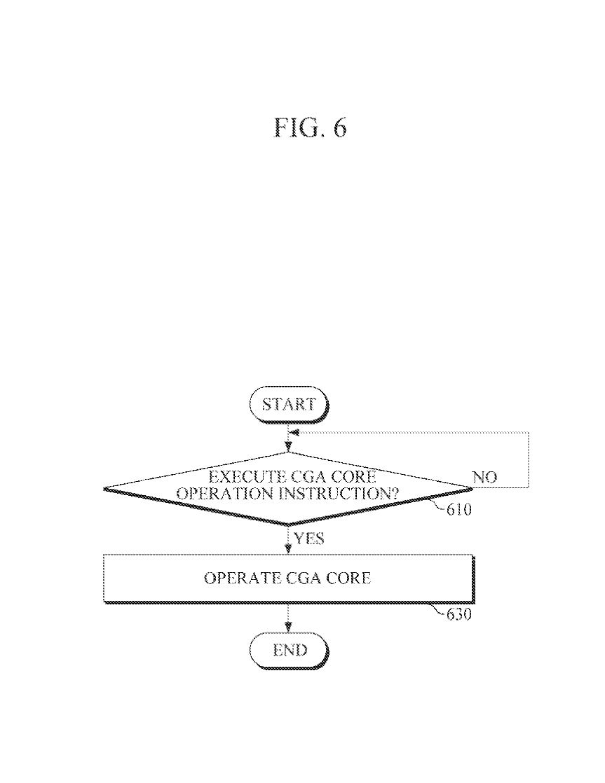

FIG. 6 is a flowchart illustrating an example of a process of controlling operations of a VLIW core 110 and a CGA core 130 if a CGA core operation instruction is executed, according to an exemplary embodiment.

Referring to FIG. 6, if a CGA core operation instruction is executed while an instruction is being executed in the VLIW core 110 in operation 610, a controller 170 may operate a CGA core 130 in operation 630.

At this time, the VLIW core 110 may execute an instruction executable in parallel with the arithmetic operation processed in the CGA core 130, which enables the VLIW core 110 and the CGA core 130 to operate in parallel, i.e., at the same time.

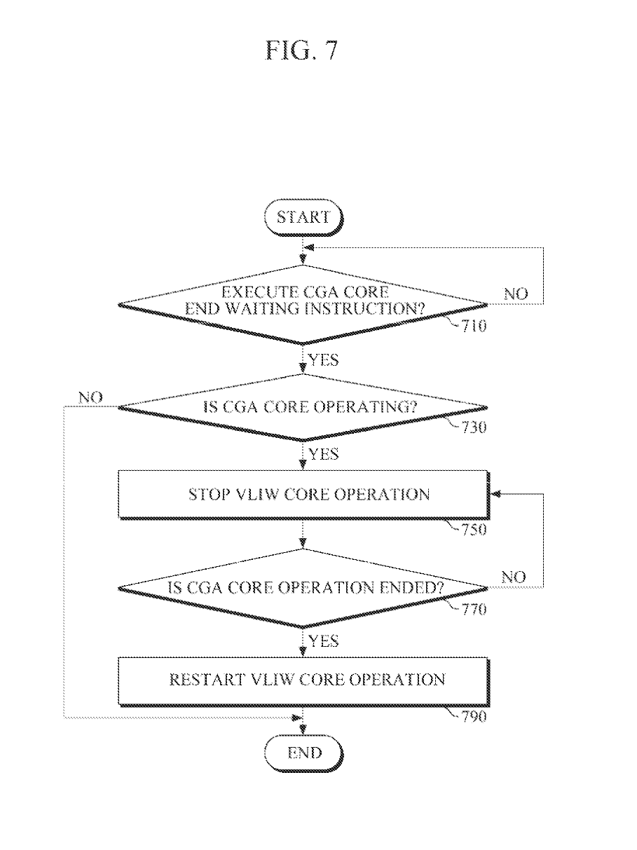

FIG. 7 is a flowchart illustrating an example of a process of controlling operations of a VLIW core 110 and a CGA core 130 if a CGA core end waiting instruction is executed, according to an exemplary embodiment.

Referring to FIG. 7, in a case in which the CGA core end waiting instruction in the VLIW core 110 is executed in operation 710, a controller 170 may determine whether the CGA core 130 is operating in operation 730.

At this time, if the CGA core 130 is operating, the controller 170 may stop an operation of the VLIW core 110 in operation 750.

Then, whether the operation of the CGA core 130 has ended is determined in operation 770. If the operation of the CGA core 130 has ended, the controller 170 may restart the operation of the VLIW core 110 in operation 790.

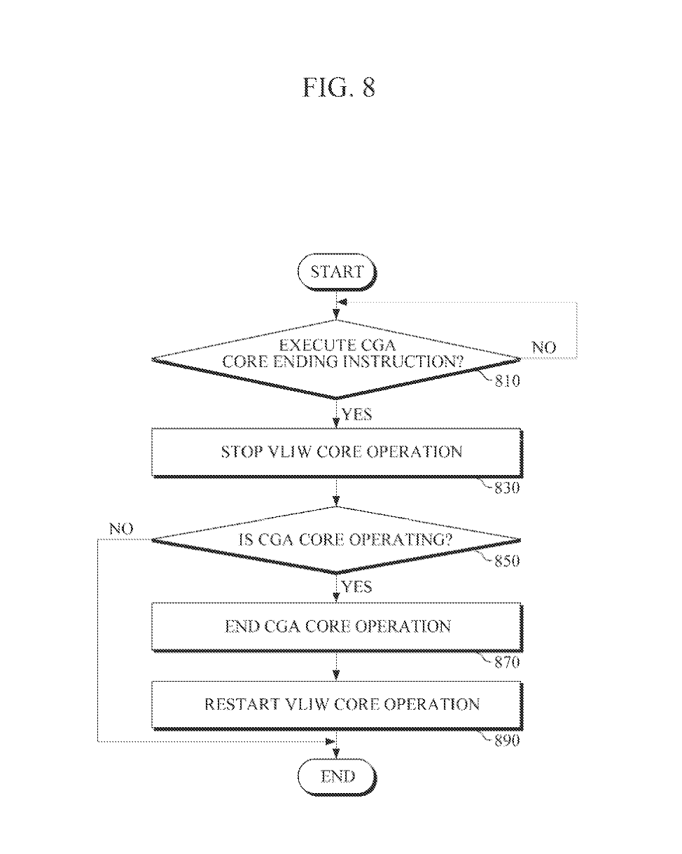

FIG. 8 is a flowchart illustrating an example of a process of controlling operations of a VLIW core 110 and a CGA core 130 if a CGA core ending instruction is executed, according to an exemplary embodiment.

Referring to FIG. 8, in a case in which a CGA core ending instruction is executed in the VLIW core 110 in operation 810, a controller 170 may stop the operation of the VLIW core 110 in operation 830.

The controller 170 determines whether the CGA core 130 is operating in operation 850. If the CGA core 130 is operating, the controller 170 may end the operation of the CGA core 130 in operation 870.

Then, after the operation of the CGA core ends in operation 870, the controller 170 may restart the VLIW core 110 in operation 890.

According to another exemplary embodiment, the controller 170 may execute the CGA core end waiting instruction together with the CGA core ending instruction in the VLIW core 110, and temporarily stop the VLIW core 110 until the operation of the CGA core 130 ends.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor, comprising:
a controller configured to control operations of a first mode, in which a first portion of a program that does not utilize loop acceleration is processed, and a second mode, in which a second portion of the program that utilizes the loop acceleration is processed, based on whether an instruction to control parallel operations of the first mode and the second mode is executed; and
a shared register file configured to transfer data between the first mode and the second mode.

2. The reconfigurable processor of claim 1, wherein the first mode operates based on a Very Long Instruction Word (VLIW) architecture.

3. The reconfigurable processor of claim 1, wherein the second mode operates based on a Coarse Grained Array (CGA) architecture.

4. The reconfigurable processor of claim 1, wherein, in response to a second mode operation instruction being executed in the first mode, the controller operates the second mode to execute an instruction and operates the first mode to execute an instruction processible in parallel with the instruction being executed in the second mode.

5. The reconfigurable processor of claim 1, wherein, in response to a second mode end waiting instruction being executed in the first mode, the controller determines whether the second mode is operating, and in response to determining that the second mode is operating, stops an operating of the first mode until the operating of the second mode ends.

6. The reconfigurable processor of claim 5, wherein the controller determines whether the second mode is operating by using a second mode end checking instruction.

7. The reconfigurable processor of claim 1, wherein, in response to a second mode ending instruction being executed in the first mode, the controller ends an operating of the second mode.

8. The reconfigurable processor of claim 1, wherein, in response to a second mode ending instruction being executed in the first mode, the controller stops an operating of the first mode, ends an operating of the second mode, and restarts the operating of the first mode.

9. The reconfigurable processor of claim 1, further comprising:
data memory, distinct from the shared register file, configured to transfer data between the first mode and the second mode.

10. A reconfigurable processor, comprising:
a VLIW core configured to operate based on a VLIW architecture;
a CGA core configured to operate based on a CGA architect;
a shared register file configured to transfer data between the VLIW core and the CGA core; and
a controller configured to control operations of the VLIW core and the CGA core based on whether an instruction to control parallel operations of the VLIW core and the CGA core is executed.

11. The reconfigurable processor of claim 10, wherein the VLIW core comprises one or more functional units and the CGA core comprises a plurality of functional units.

12. The reconfigurable processor of claim 10, wherein, in response to a CGA core operation instruction being executed in the VLIW core, the controller operates the CGA core to execute an instruction and operates the VLIW core to execute an instruction processible in parallel with the instruction being executed in the CGA core.

13. The reconfigurable processor of claim 10, wherein, in response to a CGA core end waiting instruction being executed in the VLIW core, the controller determines whether the CGA core is operating, and in response to determining that the CGA core is operating, stops an operating of the VLIW core until the operating of the CGA core ends.

14. The reconfigurable processor of claim 13, wherein the controller determines whether the second mode is operating by using a CGA core end checking instruction.

15. The reconfigurable processor of claim 10, wherein, in response to a CGA core ending instruction being executed, the controller ends an operating of the CGA core.

16. The reconfigurable processor of claim 11, wherein, in response to the CGA core not operating, the VLIW core uses at least one of the plurality of functional units of the CGA core.

17. An operation method of a reconfigurable processor, comprising:
executing an instruction in a first mode of the reconfigurable processor;
determining whether an instruction to control parallel operations of the first mode and a second mode of the reconfigurable processor is executed in the first mode; and
in response to the determining that the instruction to control the parallel operations is executed, controlling operations of the first mode and the second mode based on the executed instruction.

18. The operation method of claim 17, wherein the first mode operates based on a VLIW architecture.

19. The operation method of claim 17, wherein the second mode operates based on a CGA architecture.

20. The operation method of claim 17, wherein, in response to a second mode operation instruction being executed in the first mode, the controlling the operations of the first mode and the second mode comprises operating the second mode.

21. The operation method of claim 17, wherein, in response to the first mode processing an instruction executable in parallel with an instruction being executed in the second mode, the first mode and the second mode simultaneously operate.

22. The operation method of claim 17, wherein the controlling the operations of the first mode and the second mode comprises:
determining whether an operation of the second mode is ended in response to a second mode end waiting instruction being executed in the first mode;
stopping an operation of the first mode in a case in which the operation of the second mode is not ended; and
restarting the operation of the first mode in a case in which the operation of the second mode ends after the stopping of the operation of the first mode.

23. The operation method of claim 17, wherein, in response to a second mode operation ending instruction being executed in the first mode, the controlling the operations of the first mode and the second mode comprises ending an operation of the second mode.

24. The operation method of claim 17, wherein the controlling the operations of the first mode and the second mode comprises:
in response to a second mode operation ending instruction being executed in the first mode, determining whether the second mode is being operated;
stopping an operation of the first mode in response to determining that the second mode is operating;
ending an operation of the second mode; and
restarting the operation of the first mode after the ending the operation of the second mode.

25. A reconfigurable processor, comprising:
a first core in which a first portion of a program that does not utilize loop acceleration is processed;
a second core in which a second portion of the program that utilizes the loop acceleration is processed; and
a controller configured to control operations of the first core and the second core based on whether an instruction to control parallel operations of the first core and the second core is executed.

26. The reconfigurable processor of claim 25, further comprising a storage configured to transfer data between the first mode and the second mode.

27. The reconfigurable processor of claim 25, wherein the first core operates based on a Very Long Instruction Word (VLIW) architecture.

28. The reconfigurable processor of claim 25, wherein the second core operates based on a Coarse Grained Array (CGA) architecture.

29. The reconfigurable processor of claim 25, wherein, in response to a second core operation instruction being executed in the first core, the controller operates the second core to execute an instruction and operates the first core to execute an instruction processible in parallel with the instruction being executed in the second core.

30. The reconfigurable processor of claim 25, wherein, in response to a second core end waiting instruction being executed in the first core, the controller determines whether the second core is operating, and in response to determining that the second core is operating, stops an operating of the first core until the operating of the second core ends.

31. The reconfigurable processor of claim 30, wherein the controller determines whether the second core is operating by using a second core end checking instruction.

32. The reconfigurable processor of claim 25, wherein, in response to a second core ending instruction being executed in the first core, the controller ends an operating of the second core.
